(19) United States
(12) Patent Application Publication
(10) Pub. No.: US 2013/0152402 A1
(43) Pub. Date: Jun. 20, 2013

(54) "E-Z SPLIT" Pistachio nut opener

(71) Applicants: Dorothy Linch, Newberry Springs, CA (US); John Linch, Newberry Springs, CA (US)

(72) Inventors: Dorothy Linch, Newberry Springs, CA (US); John Linch, Newberry Springs, CA (US)

(21) Appl. No.: 13/373,227

(22) Filed: Dec. 19, 2011

(51) Int. Cl. A47J 43/26

(52) U.S. Cl. 30/120.1

(57) ABSTRACT

Our invention is used to Open Pistachio Nut Shells. The device is placed into the split end of the Pistachio nut and when light pressure is applied the nut will split open and the nut kernel is easily removed.

Our invention is made of food grade stainless steel, for ease of cleaning and sanitation. and will keep from damaging your fingernails. Our name for the Invention is “E-Z SPLIT”

An implement used to Open Pistachio Nut Shells. The implement is placed into the split end of the Pistachio nut and when light pressure is applied the nut will split open and the nut kernel is easily removed.

The implement is made of food grade stainless steel, for ease of cleaning and sanitation. Our name for the Implement is “E-Z SPLIT”

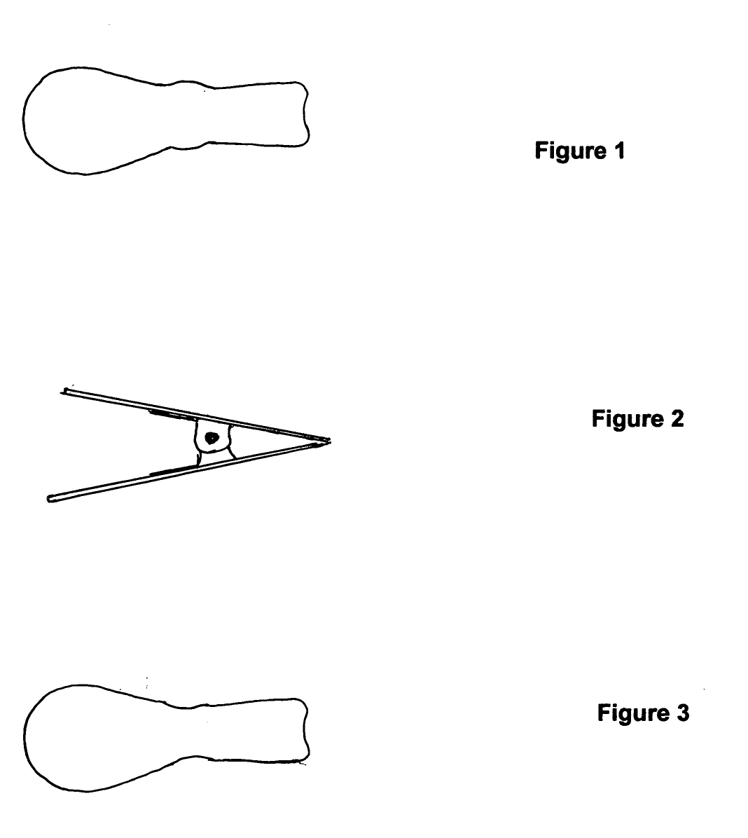

FIG. 1=Top of E-Z Split

FIG. 2=Side of E-Z Split

FIG. 3=Bottom of E-Z Split.

This invention when constructed as indicated in FIGS. 1,2,3 on pages 1 & 2 of the drawings provided, E-Z Split will make it easy to open or split the shell of the Pistachio nut, without damaging your fingernails.

I claim:

1. (E-Z Split) Comprising all the Structure.
A Spring Loaded device made of stainless steel that is used to open the hard shell of the Pistachio nut.
This is done by placing the smaller end of the E-Z Split into the split end of the Pistachio nut and pressing the spring loaded leverage end of the device, which pops the shell open.
